(19) United States
(12) Patent Application Publication
(10) Pub. No.: US 2012/0092286 A1
(43) Pub. Date: Apr. 19, 2012

(54) Synthetic Gesture Trace Generator

(75) Inventors: Christopher Jozef O'Prey, March (GB); Alisson Augusto Souza Sol, Bellevue, WA (US); Hrvoje Benko, Seattle, WA (US)

(73) Assignee: Microsoft Corporation, Redmond, WA (US)

(21) Appl. No.: 12/907,588

(22) Filed: Oct. 19, 2010

(51) Int. Cl. G06F 3/045

(52) U.S. Cl. 345/174; 178/18.06

(57) ABSTRACT

A synthetic gesture trace generator is described. In an embodiment, a synthetic gesture trace is generated using a gesture synthesizer which may be implemented in software. The synthesizer receives a number of inputs, including parameters associated with a touch sensor to be used in the synthesis and a gesture defined in terms of gesture components. The synthesizer breaks each gesture component into a series of time-stamped contact co-ordinates at the frame rate of the sensor, with each time-stamped contact co-ordinate detailing the position of any touch events at a particular time. Sensor images are then generated from the time-stamped contact co-ordinates using a contact-to-sensor transformation function. Where there are multiple simultaneous contacts, there may be multiple sensor images generated having the same time-stamp and these are combined to form a single sensor image for each time-stamp. This sequence of sensor images is formatted to create the synthetic gesture trace.

### BACKGROUND

There are many computing devices available which allow touch-based input, such as many smart phones and tablet computers. Some of these devices also offer gesture-based input, where a gesture involves the motion of a user's hand, finger, body etc. An example of a gesture-based input is a downwards stroke on a touch-screen which may translate to scrolling the window downwards. Some touch-sensitive devices can detect multiple simultaneous touch events which enables detection of multi-touch gestures. An example of a multi-touch gesture-based input is a pinching movement on a touch-screen which may be used to resize (and possibly rotate) images that are being displayed. These computing devices which offer gesture-based input comprise gesture recognizers (implemented in software) which translate the touch sensor information into gestures which can then be mapped to software commands (e.g. scroll, zoom, etc).

In order to train and evaluate gesture recognizers, recordings of actual gestures made by human users are used. However, these recordings can contain imprecise gestures and make it difficult to test the full behavior of a gesture recognizer. Furthermore, because of the subjective nature of gesture instructions given to users generating the gestures which are recorded, it may be necessary to manually check the recordings to ensure that the gestures recorded actually correspond to the expected gesture.

The embodiments described below are not limited to implementations which solve any or all of the disadvantages of known methods of training or evaluating gesture recognizers.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A synthetic gesture trace generator is described. In an embodiment, a synthetic gesture trace is generated using a gesture synthesizer which may be implemented in software. The synthesizer receives a number of inputs, including parameters associated with a touch sensor to be used in the synthesis and a gesture defined in terms of gesture components. The synthesizer breaks each gesture component into a series of time-stamped contact co-ordinates at the frame rate of the sensor, with each time-stamped contact co-ordinate detailing the position of any touch events at a particular time. Sensor images are then generated from the time-stamped contact co-ordinates using a contact-to-sensor transformation function. Where there are multiple simultaneous contacts, there may be multiple sensor images generated having the same time-stamp and these are combined to form a single sensor image for each time-stamp. This sequence of sensor images is formatted to create the synthetic gesture trace.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows two schematic diagrams: the upper diagram shows a gesture recognizer in use and the lower diagram shows the operation of a gesture synthesizer;

FIG. 2 is a flow diagram of an example method of synthetic gesture trace generation;

FIGS. 3 and 4 show example methods of generating sensor images;

FIG. 5 shows an example contact-to-sensor function for a circular contact and a diagram of this contact overlaid on a sensor grid;

FIG. 6 is a flow diagram of an example method of generating a series of time-stamped contact co-ordinates;

FIG. 7 shows diagrams explaining the origins of jitter and curvature contact co-ordinate corrections; and

FIG. 8 illustrates an exemplary computing-based device in which embodiments of the methods of synthetic gesture trace generation may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Training a gesture recognizer using recordings of actual gestures is problematic because the recordings can contain imprecise gestures and it is very difficult to obtain a range of recordings which test the full behavior of a gesture recognizer. Training and evaluation of a gesture recognizer can be improved through use of synthetically generated gestures and methods and apparatus for synthesizing gestures are described below. With synthesized gestures, the gestures can be made with a precision and regularity which a human generating a gesture recording cannot replicate. This enables a more thorough evaluation of the code within a gesture recognizer, in particular by exploring the boundary cases for recognizing gestures (e.g. gestures which are only just long enough to qualify as a particular gesture, or are very quick or slow, or start at the boundary of a defined ‘start’ region for a gesture, etc).

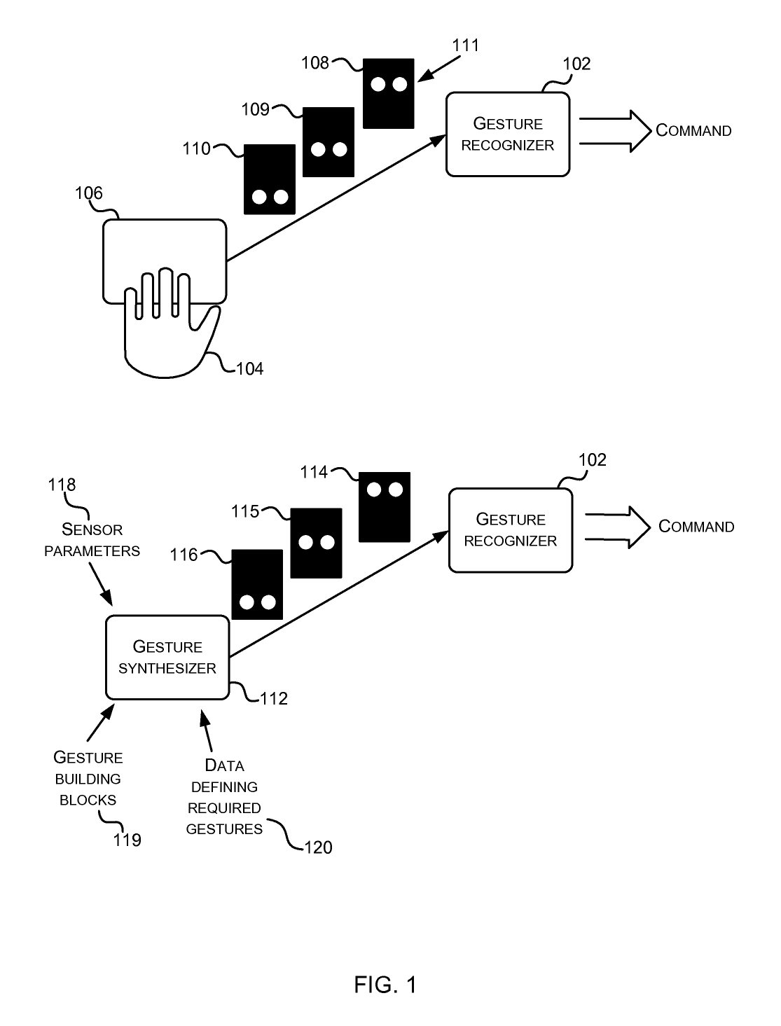

FIG. 1 shows two schematic diagrams and the upper diagram shows a gesture recognizer 102 (which may be a parametric gesture recognizer) in use. A user performs a gesture with their hand/fingers 104 on a capacitive touch sensor 106, such as a downwards stroke with two fingers. This sensor may be part of a touch-sensitive display or other touch-sensitive device (e.g. touch-sensitive mouse or tablet) which is connected to, or integrated with, a computing device (e.g. a desktop, laptop or tablet computer, a smart phone, a games console etc). The touch sensor 106 captures a series of sensor images 108-110 at the output frequency of the sensor (e.g. 115 or 120 frames per second, although this value may vary considerably depending upon the sensor technology used) which effectively provide a map of capacitance across the sensor area at each instance in time. In the simple example shown in FIG. 1, it can be seen that the white regions 111 caused by a user's fingers touching the sensor are in different positions in different images, thereby recording the downward stroke motion of the user's fingers. The series of images may be compressed and/or otherwise formatted into data packets (e.g. USB packets where the touch-sensitive device is a USB peripheral device) for output by the touch sensor 106 and input into the gesture recognizer 102. The gesture recognizer 102 analyzes the series of sensor images to identify the gesture performed and may then output this gesture data. Alternatively, as shown in FIG. 1, the gesture recognizer maps the identified gesture to a software command (e.g. “scroll window”) and outputs this command to the appropriate software, which may be the operating system or application software on the computing device.

The lower diagram in FIG. 1 shows a gesture synthesizer 112 which generates a synthetic gesture trace comprising a series of synthesized sensor images 114-116 appropriately formatted (e.g. such that its format is the same as a recorded gesture, as described above) for input into a gesture recognizer 102. In one example, the gesture recognizer 102 may be a parametric gesture recognizer. In another example, the gesture recognizer 102 may be an artificial intelligence (AI) gesture recognizer. The input data received by the gesture recognizer can then be used to evaluate or train the gesture recognizer 102 which, as described above, analyzes the series of sensor images, identifies a gesture and then outputs data which may identify the gesture or correspond to a command which controls an operating system or application software. In order to generate the synthetic trace, the gesture synthesizer 112 receives a number of inputs 118-120.

One of the inputs 118 comprises parameters associated with the sensor (e.g. sensor 106) the operation of which is being synthesized. Such parameters may comprise some or all of: the physical dimensions of the sensor (e.g. height and width), the number of sensor points (e.g. a grid of 15×13 cells), the output frequency (e.g. in frames/second) and the number of quantization levels of capacitance that the sensor is aware of (e.g. 32 levels). There may also be additional parameters such as the base capacitance level, i.e. the capacitance value of the sensor when there is no contact with the sensor, (e.g. if it is non-zero, as described below), data specifying the sensor layout where it comprises an irregular grid of cells, the percentage of a sensor which may fail, etc. Through specification of the appropriate parameters in this input 118, the synthesizer 112 may be used to generate synthetic traces for any capacitive sensor and these sensors may be used in many different types of devices, from small devices (e.g. smart phones or touch-sensitive mice or input pads) to very large devices (e.g. surface computers or large touch-sensitive televisions).

Another of the inputs 119 comprises data on building blocks (which may also be referred to as ‘gesture components’) from which gestures may be constructed. These building blocks may themselves be constructed from geometric constructs, e.g. a labeled 5-part vector describing a vertical scroll movement. In an example, each building block may be defined as a vector comprising the start and end coordinates of the movement (normalized so that they are in the range 0 to 1), the duration of the gesture and a unique ID (which may be referred to as a ‘vector tag’). The building block may also comprise timing information, such as any time offset before the gesture starts (e.g. 3 seconds from the start of “recording”) and/or the time taken to perform a gesture (for example, if you start to move a single finger “fast enough” then this may be interpreted as doing a “flick” and correspond to one command, whereas moving the same finger “slowly” should be considered a “scroll” and in such an example, the timing information may detail the amount of time for a finger to move between the start and end points). Where timing information is included, it may be in terms of absolute values or normalized values. In some examples, however, any timing information that is required may be put at a higher level (e.g. in the data defining the required gestures 120). In an example, each building block describes a single-touch gesture (e.g. a gesture using a single finger) and a multi-touch gesture may be built up from multiple building blocks (e.g. 3 distinct IDs would be used to form a three finger gesture). Single-touch gestures may also be built up from multiple building blocks, as described in more detail below. In some examples, a building block may have multiple segments and so may be defined in terms of one or more vectors.

A further one of the inputs 120 comprises data which defines the gestures which are to be synthesized by reference to one or more building blocks (or gesture components) and may be referred to as ‘gesture data’. In an example, this data may be provided in the form of an input script, which may be an XML file, which defines one or more output file names and for each output file name provides a sequence of building block IDs with any necessary timing information (e.g. where it is not provided within a building block). Complex gestures may be built up from a sequence of line segments, each defined by a separate building block. Each output file name corresponds to a generated synthetic trace and through use of such an input script, many traces can be defined for generation. In an example, the input script may also include the sensor parameters 118 described above, particularly where the sensor parameters 118 are the same for all traces generated by a single script but may be different for other input scripts. Alternatively, the input script may include a reference to a particular set of sensor parameters 118. In an example, the building block vectors themselves may be included within the input script (in addition to, or instead of, the building block IDs); however, it may be more efficient and flexible to store the building block data separately to the scripts such that the gesture synthesizer 112 accesses the required building blocks as defined by the input script.

An example of an input script in XML is shown below which comprises a three level structure: a <file> may contain multiple <vector> entries, each for a specific contact path. These in turn may contain multiple <line> entries (which each correspond to a building block) which define the line segments which make up the contact path. Multiple building blocks may therefore be used to define complex paths for a single contact.

<?xml version=“1.0” encoding=“utf-8” ?>
- <configuration>

<sensor width=“20” height=“10” frequency=“115”

baseCapacitance=“0” capacitanceLevels=“31” />
- <!-- Vertical single finger movement -->
- <file path=“Vertical.synth”>
- <vector id=“0”>

<line from=“0.5,0.1” to=“0.5,0.9” startAtSecond=“0”

takenMilliseconds=“500” jitter=“0.05” />

</vector>
</file>

- <!-- Horizontal single finger movement -->
- <file path=“Horizontal.synth”>
- <vector id=“0”>

<line from=“0.35,0.3” to=“0.75,0.3” startAtSecond=“0”

takenMilliseconds=“500” jitter=“0.05” curve=“0.01” />

</vector>
</file>

- <!-- Vertical two finger movement -->
- <file path=“TwoFingerVertical.synth”>
- <vector id=“0”>

<line from=“0.4,0.1” to=“0.4,0.8” startAtSecond=“0”

takenMilliseconds=“500” />

</vector>

- <vector id=“1”>

<line from=“0.6,0.1” to=“0.6,0.8” startAtSecond=“0”

takenMilliseconds=“500” />

</vector>
</file>

- <!-- Compound movement -->
- <file path=“Compound.synth”>
- <vector id=“0”>

<line from=“0.1,0.9” to=“0.3,0.9” startAtSecond=“0.75”

takenMilliseconds=“250” />

<line from=“0.3,0.9” to=“0.3,0.7” startAtSecond=“1”

takenMilliseconds=“500” />

</vector>
</file>
</configuration>

There are many different ways that an input script (e.g. as described above) could be generated and in an example the script may be generated by hand, i.e. defined from line segments (as described above). In another example, however, the script may be extracted from an existing gesture recording and then some noise or spatial/temporal shifting may be added. This example generates alternatives to existing recorded gestures. For example, using this method, the synthetic gesture generator may be used to generate the traces for slowed down (or speeded up) motions of existing user gestures. In a further example, the script may be a creative morph of one or more gesture traces to generate new traces which can be used to test or train a gesture recognizer. In yet another example, the script may be generated using a degree of randomness in order to simulate many (or all) possibilities of what the sensor could sense, regardless of whether fingers or not are used. Such a script could be used to detect noise in a sensor or to remove inadvertent actuation. In a further example, an existing gesture dataset recorded on a different device may be used to generate scripts for a new sensor/device (even where the existing sensor and the new sensor are of a completely different form) and then the new synthesized gesture data could be used to test the gesture recognition. Where the existing and new sensors have a different form or otherwise are very different, the generation of scripts may use a topological or form fitting function.

Although FIG. 1 and the following description describes systems and methods which receive three inputs 118-120, in some examples, some of these inputs may not be used or may be fixed in value (e.g. in the form of hard-coded assumptions) so that they do not need to be input for each particular generation operation (e.g. the sensor parameters 118 may always be the same and so may be hard-coded, the gesture building blocks 119 may be always the same and/or a defined gesture or set of gestures may always be generated so that the data defining the required gestures 120 may be fixed). There may also be one or more additional inputs, such as gesture synthesizer parameters which may be implementation dependent.

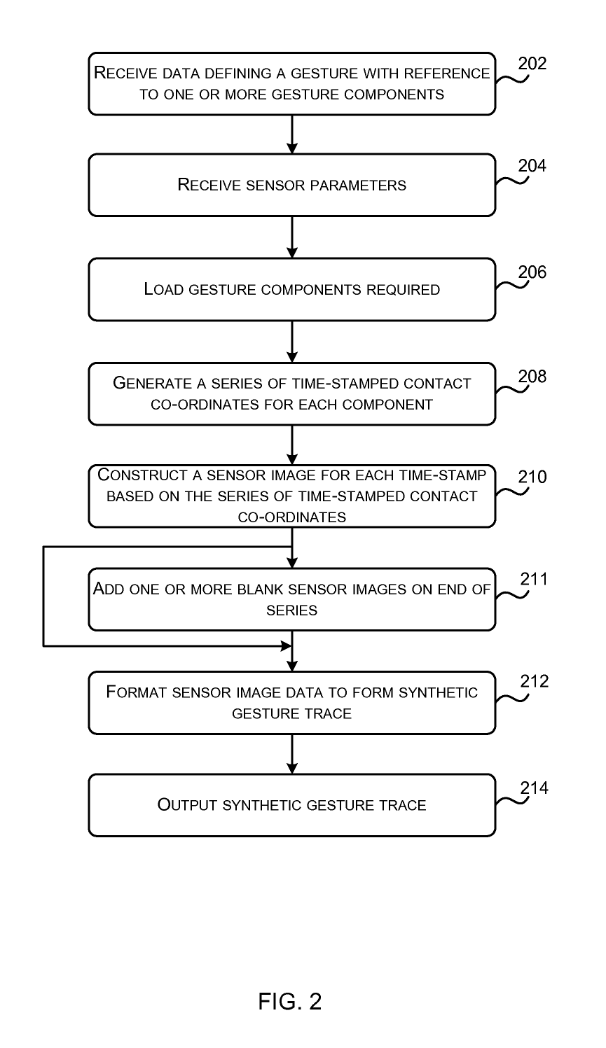

FIG. 2 is a flow diagram of an example method of operation of a gesture synthesizer 112 and shows a method of synthetic gesture trace generation. The gesture synthesizer 112 receives data 120 defining a gesture with reference to one or more gesture components or building blocks (block 202), e.g. by reference to gesture component IDs. The synthesizer also receives sensor parameters 118 (block 204). The two inputs (in blocks 202 and 204) may be received in the form of an input script (which may be an XML file) which contains both pieces of data, as described above. The process of receiving the data (in blocks 202 and 204) may comprise receiving the data from another entity or may involve accessing the data from an entity, such as a data store. The synthesizer loads the gesture components which are required (block 206), i.e. those components which are specified in the input received in block 202. It will be appreciated that if the input script includes the gesture components (as in one of the examples described above), the steps of receiving data defining gestures (in block 202) and loading gesture components (in block 206) may be combined or blocks 202, 204 and 206 may be combined in a single operation where all the input information is contained within an input script.

Based on the input data (from blocks 202-206) the synthesizer generates a series of time-stamped contact co-ordinates for each gesture component (block 208). The contact co-ordinates are generated at the frame rate of the sensor (as detailed in the data received in block 204), such that, in a simple example, if a gesture component defines a movement which starts at time t=0 and lasts for 1 second, a contact co-ordinate would be generated for that gesture component at each of t={0, 1/f, 2/f, 3/f, . . . , f/f} seconds where f is the frame rate of the sensor in frames/second. In generating the contact co-ordinates (in block 208), the normalized co-ordinates specified in the gesture component may be scaled according to the actual dimensions of the sensor (as defined in the sensor parameters received in block 204). Alternatively, the values of the co-ordinates may be scaled to real-world values at the stage where the sensor image's capacitance levels are calculate (i.e. in block 210). The contact co-ordinates for each time-stamp are generated (in block 208) by dividing the total motion into the appropriate number of steps given the time taken to complete the motion and the frame rate of the sensor (f steps in the simple example given). The process is repeated (within block 208) for each gesture component to produce a series of time-stamped contact co-ordinates for each gesture component.

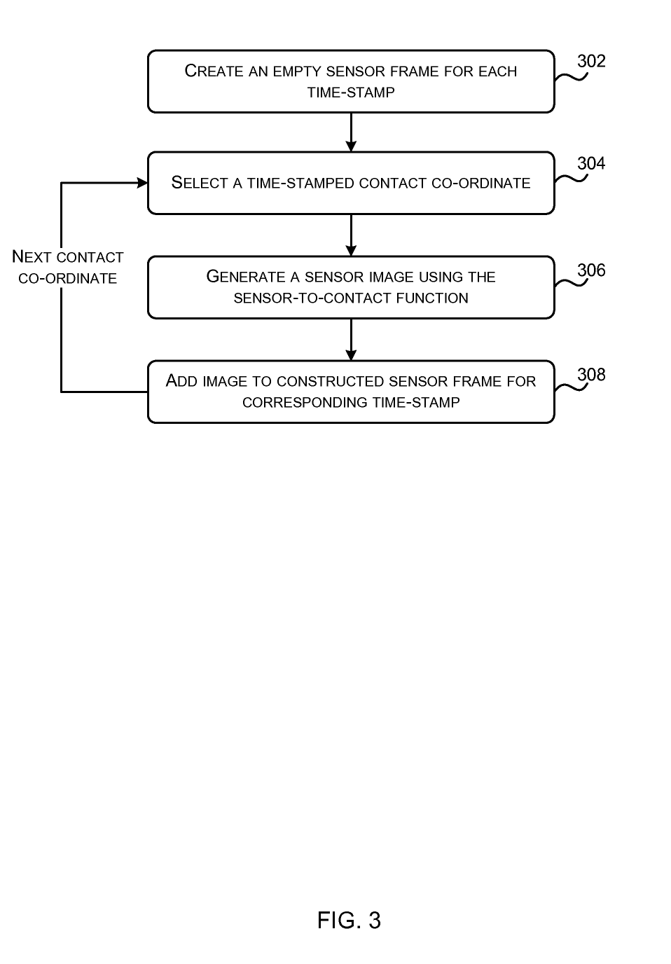

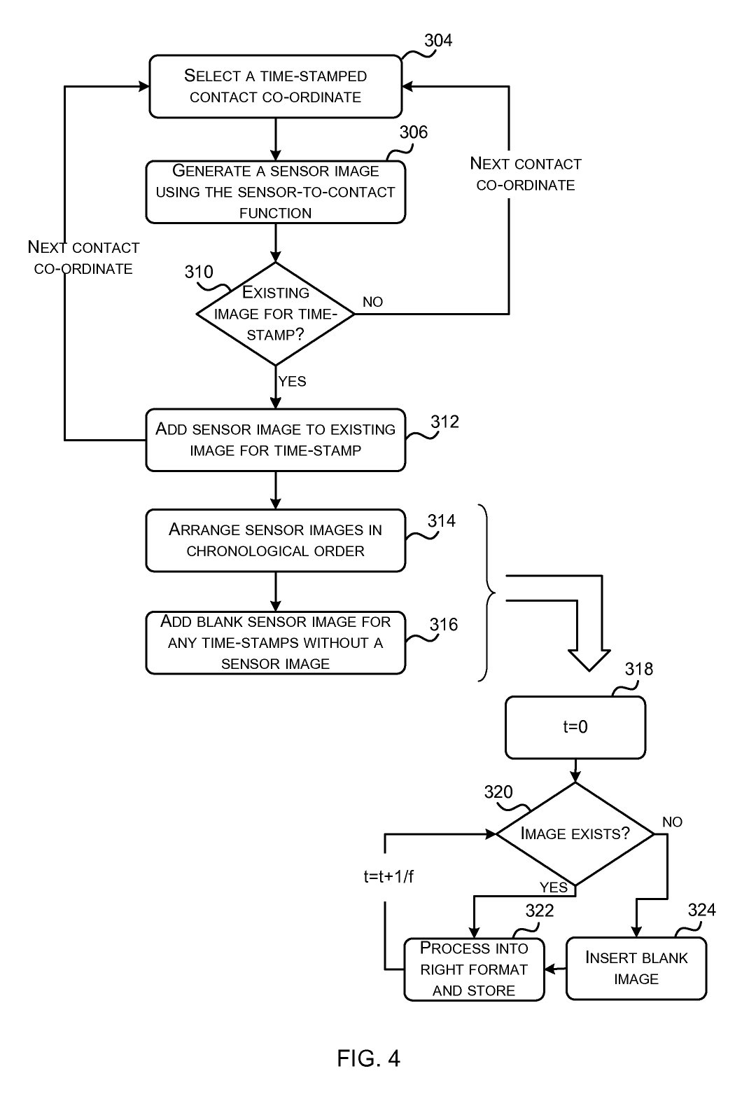

A sensor image is constructed for each time-stamp (in block 210) based on the series of time-stamped contact co-ordinates (generated in block 208) and a contact-to-sensor function and two example methods of performing this are shown in the flow diagrams of FIGS. 3 and 4. As shown in the first example method shown in FIG. 3, an empty sensor frame is created for each time-stamp (block 302), where an empty sensor frame comprises capacitance values at every point which are representative of no contact (i.e. values which are equal to the base capacitance value). The nature of this empty frame is dependent upon the type of sensor specified, because some sensors have low levels where there is no contact and increased values where there is contact and other sensors operate in the opposite way (generally a mean level for no contact and reducing values where there is contact). Each of the time-stamped contact co-ordinates (generated in block 208 of FIG. 2) are then selected in turn (in block 304) and for each selected contact co-ordinate, a sensor image is generated using a sensor-to-contact function (block 306). The generated sensor image is then added to the constructed sensor frame for the corresponding time-stamp (in block 308). Where there are multiple contacts at any time (e.g. for multi-touch gestures), there will be multiple contact co-ordinates having the same time-stamp and multiple sensor images (one per contact co-ordinate) will be added to the constructed sensor frame. It is the final sensor frame for each time-stamp (once all time-stamped contact co-ordinates have been processed by repeating blocks 304-308) which is persisted.

In the second example method shown in FIG. 4, a time-stamped contact co-ordinate is selected (block 304) and a sensor image is generated using a sensor-to-contact function (block 306). If there is already an existing sensor image for the particular time-stamp (as determined in block 310), then the newly generated sensor image (from block 304) is added to the existing sensor image (block 312). As before, the process is repeated for each of the time-stamped contact co-ordinates generated for each gesture component (in block 208 of FIG. 2). Once all the contact co-ordinates have been processed (in blocks 304, 306, 310 and 312), the sensor images are arranged into chronological order (block 314) and if there are any time-stamps for which a sensor image has not yet been generated (in block 306), a blank (or empty) sensor image is added for the particular time-stamp (block 316). This blank (or empty) sensor image is the same as described above with reference to block 302, i.e each element in the image has a value equal to the base capacitance value (which may be zero or may be a non-zero value). In an example, the processing of images into chronological order (in block 314) and insertion of blank images may be implemented by starting at the start time (block 318, e.g. t=0) and if an image exists with this time-stamp (‘Yes’ in block 320), the image is processed into the right format (if required) and stored (in block 322). If no image exists with this time-stamp (‘No’ in block 320), a blank image is inserted (block 324), which may then be formatted (if required) and stored (in block 322) before the method is repeated to loop through each frame in turn (e.g. at a time interval of 1/f, where f is the frame rate of the sensor) until there are no sensor images left in the queue of calculated sensor images to process.

It can be seen that the two methods shown in FIGS. 3 and 4 achieve the same end result by performing the method blocks in a slightly different order and in a slightly different way. It will be appreciated that there may be further methods which achieve the same result and that the method blocks shown in FIGS. 3 and 4 may be performed in other orders whilst still constructing a sensor image for each time-stamp based on the series of time-stamped contact co-ordinates for each gesture component. As described above, block 210 may also involve conversion of the contact co-ordinates to real-world values (based on the sensor parameters received in block 204) if this conversion was not performed in generating the co-ordinates in block 208. It will also be appreciated that in a variation of that shown in FIG. 2, blocks 208 and 210 may be combined such that once a time-stamped contact co-ordinate is generated, a corresponding sensor image is constructed and then a next time-stamped contact co-ordinate may be generated and the method repeated.

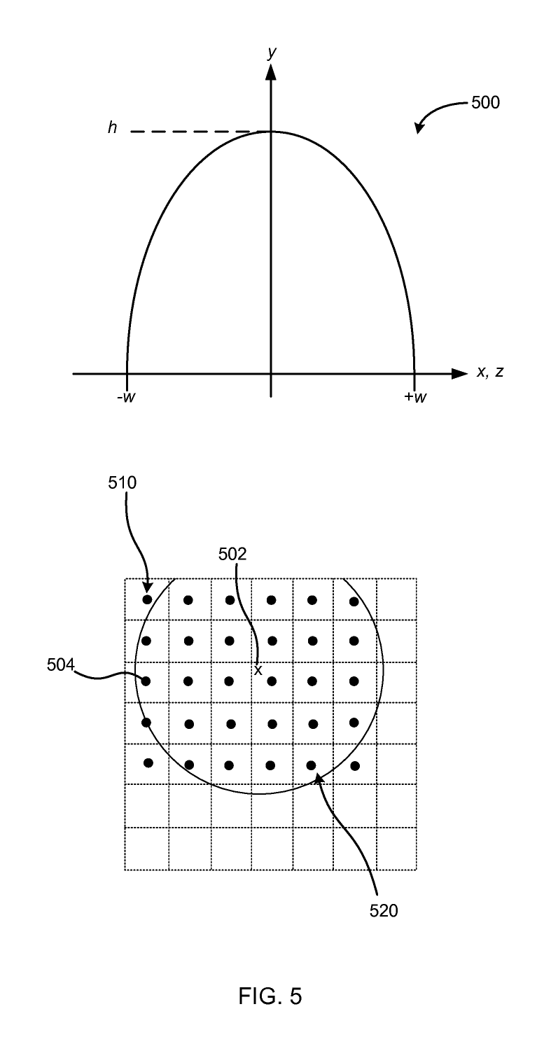

FIG. 5 shows an example contact-to-sensor function 500 for a circular contact such as a finger contact. The value w specifies the maximum contact size (in an example, w=3) which may be selected to correspond to the size of a real finger tip and the value h is the set by the number of levels of capacitance that the sensor detects (e.g. 32 levels, 0-31, so h=31). The contact-to-sensor function may alternatively have a different form (e.g. an oval shaped contact for a thumb or where the ‘no contact’ capacitance is non-zero). To generate a sensor image using such a function (in block 306), the function is centered on the selected contact co-ordinate (marked with an ‘x’ 502 in the lower part of FIG. 5) and the value of the function computed for the centers 504 of each sensing cell (as marked by dots in FIG. 5). In an example, the function may have the form:

$$y = - \frac{( - \frac{h}{{w}^{2}} {x}^{2} + h )}{{( w - x )}^{2}} {z}^{2} + ( - \frac{h}{{w}^{2}} {x}^{2} + h )$$

However, this can be simplified to:

y=y₁y₂h

where: y₁=1−(w⁻²x²)

y₂=1−(w⁻²z²)

The resultant sensor image comprises a matrix of capacitance values (which may be defined in terms of the levels of capacitance that the sensor detects) at each cell center. In an example, the matrix for the 7×7 grid shown in the lower part of FIG. 5, may be:

$$( \begin{matrix}3 & 13 & 19 & 20 & 17 & 9 & 0 \\ 5 & 19 & 27 & 29 & 24 & 13 & 0 \\ 5 & 20 & 29 & 31 & 25 & 13 & 0 \\ 4 & 17 & 24 & 25 & 21 & 11 & 0 \\ 2 & 9 & 13 & 13 & 11 & 6 & 0 \\ 0 & 0 & 0 & 0 & 0 & 0 & 0 \\ 0 & 0 & 0 & 0 & 0 & 0 & 0\end{matrix} )$$

When adding a sensor image to an existing sensor image (e.g. in block 308 or 312) and where the images have contact areas which partially overlap (e.g. due to two fingers being next to each other and in contact with each other), the way the two images are added takes into consideration the sensor type and the way that the sensor responds to touch events. In the example described above with reference to FIG. 5, the capacitance when there is no contact is equal to level zero (the base capacitance value) and in this case, the combination of sensor images may be performed by addition of matrices. For example, for two touch events (at locations 510, 520, as shown in the lower part of FIG. 5) with the following matrices:

$$( \begin{matrix}31 & 28 & 17 & 0 & 0 & 0 & 0 \\ 28 & 24 & 15 & 0 & 0 & 0 & 0 \\ 17 & 15 & 10 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0\end{matrix} ) , ( \begin{matrix}0 & 0 & 0 & 0 & 0 & 0 & 0 \\ 0 & 0 & 0 & 0 & 0 & 0 & 0 \\ 0 & 0 & 10 & 15 & 17 & 15 & 10 \\ 0 & 0 & 15 & 24 & 28 & 24 & 15 \\ 0 & 0 & 17 & 28 & 31 & 28 & 17 \\ 0 & 0 & 15 & 24 & 28 & 24 & 15 \\ 0 & 0 & 10 & 15 & 17 & 15 & 10\end{matrix} )$$

the resultant matrix will be:

$$( \begin{matrix}31 & 28 & 17 & 0 & 0 & 0 & 0 \\ 28 & 24 & 15 & 0 & 0 & 0 & 0 \\ 17 & 15 & 20 & 15 & 17 & 15 & 10 \\ 0 & 0 & 15 & 24 & 28 & 24 & 15 \\ 0 & 0 & 17 & 28 & 31 & 28 & 17 \\ 0 & 0 & 15 & 24 & 28 & 24 & 15 \\ 0 & 0 & 10 & 15 & 17 & 15 & 10\end{matrix} )$$

In an example where the base capacitance value is non-zero (e.g. 200), the actual sensor images may be calculated as described above, but in generating the final image (e.g. the resultant matrix above), all the images for a particular time-stamp may be subtracted from the base image. Using the example above, the resultant matrix would be:

$$( \begin{matrix}169 & 172 & 183 & 200 & 200 & 200 & 200 \\ 172 & 176 & 185 & 200 & 200 & 200 & 200 \\ 183 & 185 & 180 & 185 & 183 & 185 & 190 \\ 200 & 200 & 185 & 176 & 172 & 176 & 185 \\ 200 & 200 & 183 & 172 & 169 & 172 & 183 \\ 200 & 200 & 185 & 176 & 172 & 176 & 185 \\ 200 & 200 & 190 & 185 & 183 & 185 & 190\end{matrix} )$$

In some examples, it may be useful to add at least one blank (or empty) sensor image onto the end of the series of sensor images (block 211). In an example, eight blank sensor images may be added onto the end of the series of images generated in block 210. These one or more blank sensor images at the end of the data may enable the gesture recognizer 102 to recognize the end of a gesture and/or may be used to clear any cache of sensor images within the gesture recognizer.

Having generated the series of sensor images (in block 210, e.g. as shown in the flow diagram in FIG. 3 or 4, and in some examples with the addition of some blank sensor images in block 211), the sensor image data is formatted to form the synthetic gesture trace (block 212 of FIG. 2). This formatting may, for example, comprise encoding the data (e.g. using run-length encoding) and adding headers to create one or more data packets. These data packets may, for example, be USB packets. Once formatted appropriately, the synthetic gesture trace is output (block 214) to a gesture recognizer, to a data store or other entity.

Although the gesture synthesizer is described above as generating a synthetic gesture trace comprising a series of synthesized sensor images in a format that is the same as a recorded gesture, in some examples the format may not be the same (e.g. it may be slightly different to a recorded gesture). For example, a user input device (such as a touch-sensitive mouse) may produce the series of images from a recorded gesture in the form of multiple USB packets per sensor frame and the gesture synthesizer may produce a corresponding set of images but with one USB packet per frame.

The synthesizer may be able to output more than one type of file and a synthesizer may output a single file type for a synthesized gesture or may output a number of files of different types for a single synthesized gesture. A first example output file is a binary file which comprises the sensor data (described above), a free-form data block detailing information regarding the sensor being synthesized (e.g. device type) and in addition, for each time-stamp, records details of any active contact points and whether these contact points are the start/middle/end of a gesture. A second example output file is an XML file which comprises a binary stream of sensor data (run-length encoded, as described above) and a free-form data block (which may detail information regarding the sensor being synthesized). A third example output file (which may also be an XML file) details just the series of time-stamped contact co-ordinates without the sensor data and this file may be used to control a robot for automated device verification, as described in more detail below. In a variation of this third example, the output file may comprise vector instructions instead of the time-stamped contact co-ordinates, for example where the particular robot implementing the commands only requires instructions to start moving in a defined direction at a particular speed and instructions to stop moving for particular time-stamps, rather than specific co-ordinates for each time-stamp.

The example method shown in FIG. 2 shows the generation of one synthetic gesture trace. It will be appreciated, however, that the method may be repeated to generate multiple synthetic gesture traces and these multiple gestures may be defined within a single input script. The use of a single input script which can generate multiple synthetic gesture traces provides a very compact format for the data which provides efficiencies in data storage and communication (e.g. where the scripts are communicated across a network, for example, by email). Where multiple traces are generated from a single script, some of the method blocks may be performed only once (e.g. block 204) rather than being repeated for each iteration of the method which generates a synthetic gesture trace for a different gesture.

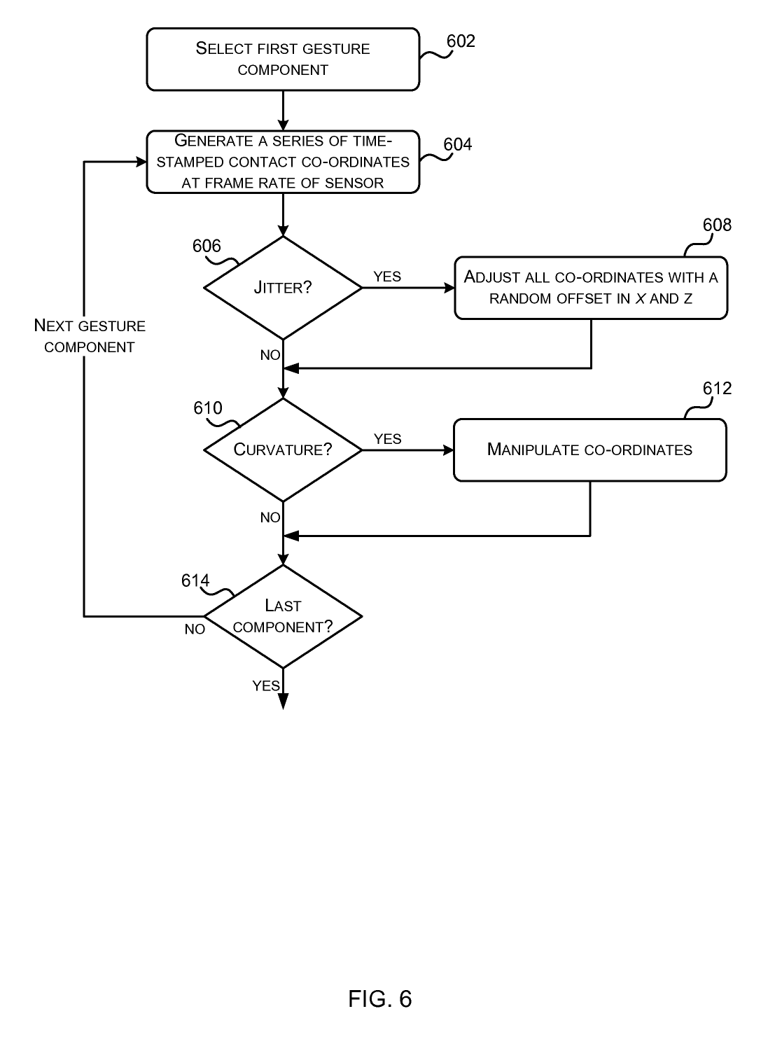

In the example described above, the series of time-stamped contact co-ordinates are generated (in block 208) by dividing the motion into the same number of steps as there are frames. In some examples, however, the resultant co-ordinates may then be adjusted (within block 208 of FIG. 2) to take account of one or more other factors and an example of this is shown in the flow diagram of FIG. 6. In the method shown in FIG. 6, once the series of time-stamped contact co-ordinates have been generated for a particular gesture (in block 604, e.g. by dividing the motion into a step for each sensor frame) there are two additional factors which may be taken into consideration for a particular gesture component and this may be specified in the gesture data (e.g. the input script) received in block 202 of FIG. 2. It will be appreciated however, that in other examples, only one of these additional factors may be used or other factors may be used in addition to or instead of those shown in FIG. 6.

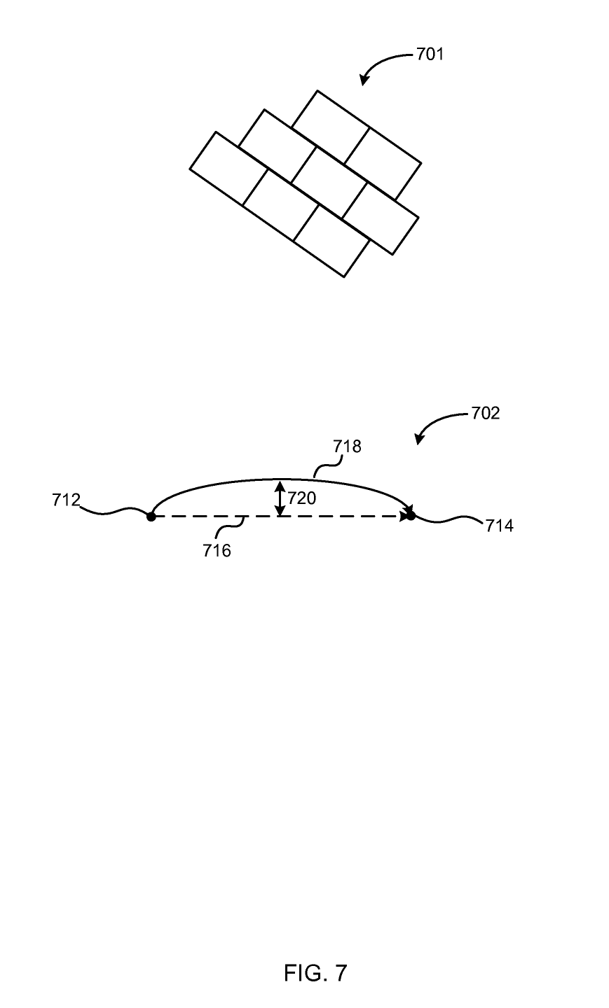

The first of the parameters considered in FIG. 6 is jitter and this may be specified in the gesture data (e.g. the input script) using a Boolean value. Jitter is used in this context to synthesize the fact that, although the sensor matrix is shown as a rectangular grid (as shown in the lower part of FIG. 5), each sensor cell is actually kite (or diamond) shaped and cells in adjacent rows are offset from each other, as shown in the first diagram 701 in FIG. 7. If jitter is to be synthesized for a selected gesture (‘Yes’ in block 606), each of the time-stamped contact co-ordinates which have been generated (in block 604, e.g. as described above with reference to block 208 of FIG. 2) for the gesture (as selected in block 602) are adjusted with a random offset in x and z (block 608), i.e. in the plane of the sensor. Parameters may be provided which indicate the degree of jitter required and in an example this may be provided in a building block (and may comprise a normalized value, typically 0.05). Including these parameters at the building block level provides more flexibility when defining gestures, but the parameters may alternatively be defined elsewhere (e.g. in the sensor data or input script). The specified jitter parameter affects the size of the offsets applied to the contact co-ordinates (in block 608).

The second of the parameters considered in FIG. 6 is curvature and a numeric input of the amount of curvature required (which may be zero, indicating no curvature, or a positive or negative value) may be specified at the building block level, in the gesture data (e.g. in the input script) or elsewhere. Again, by specifying this parameter at a building block level there is more flexibility. Curvature is used in this context to simulate genuine biometric motion of fingers: often when a user sweeps their finger in what is intended to be a horizontal line (from the start position 712 to the end position 714, as indicated by dotted arrow 716), the resultant gesture is actually a curve (as indicated by solid arrow 718), as shown in the second diagram 702 in FIG. 7. This curvature is due to the fact that when performing the gesture the user holds their hand stationary and so, as the moving finger is joined to the hand at one end, the finger tip traces an arc. The numeric input defining the curvature may indicate the offset 720 required at the center (or midpoint) of the gesture or may be defined in another way (e.g. in terms of Bezier control points). If curvature is required to be synthesized (as determined in block 610), each of the series of contact co-ordinates are manipulated (in block 612) using the numeric input specified so that they lie on an arc rather than a straight line. By defining the curvature in terms of a central offset 720, this manipulation can be performed very quickly and efficiently and equations can be defined in software (based on the principles of Bezier curves) to perform the manipulation.

In an example embodiment of a gesture synthesizer, the synthetic gesture traces may be generated using a number of assumptions. These assumptions may comprise: that all files generated start at the same time offset (e.g. t=0) and the size and shape of the contact generated (e.g. the finger size, which may, for example, be as shown in the upper diagram of FIG. 5). Use of the assumption regarding time offset assists in generating the empty sensor frames (in block 302) or in ordering the sensor images (in block 314). All additional information required to generate the synthetic gesture traces may be provided by an input script (including the sensor parameters and the gesture components).

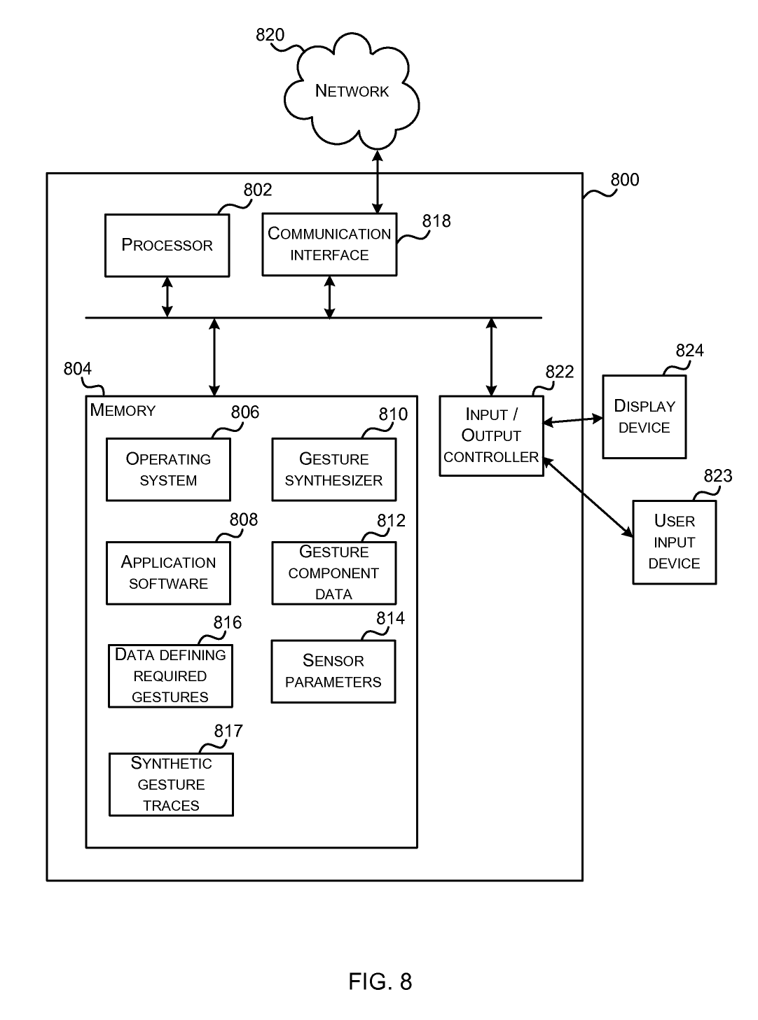

FIG. 8 illustrates various components of an exemplary computing-based device 800 which may be implemented as any form of a computing and/or electronic device, and in which embodiments of the methods described above may be implemented.

Computing-based device 800 comprises one or more processors 802 which may be microprocessors, controllers or any other suitable type of processors for processing computing executable instructions to control the operation of the device in order to generate synthetic gesture traces. In some examples, for example where a system on a chip architecture is used, the processors 802 may include one or more fixed function blocks (also referred to as accelerators) which implement a part of the method of generating a synthetic gesture trace in hardware (rather than software or firmware). Platform software comprising an operating system 806 or any other suitable platform software may be provided at the computing-based device to enable application software 808, including a gesture synthesizer 810, to be executed on the device.

The computer executable instructions may be provided using any computer-readable media that is accessible by computing based device 800. Computer-readable media may include, for example, computer storage media such as memory 804 and communications media. Computer storage media, such as memory 804, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device. In contrast, communication media may embody computer readable instructions, data structures, program modules, or other data in a modulated data signal, such as a carrier wave, or other transport mechanism. Although the computer storage media (memory 804) is shown within the computing-based device 800 it will be appreciated that the storage may be distributed or located remotely and accessed via a network or other communication link (e.g. using communication interface 818).

The memory 804 may also be used to store one or more of the gesture component data 812, the sensor parameters 814, the data defining required gestures 816 and the generated synthetic gesture traces 817. The input data 812, 814, 816 to the gesture synthesizer 810 may alternatively be received via the communication interface 818 or be input directly by a user (e.g. via input/output controller 822).

The computing-based device 800 may also comprise an input/output controller 822 which is arranged to receive and process input from one or more devices, such as a user input device 823 (e.g. a mouse or a keyboard). As described above, this user input may be used to provide input data for the gesture synthesizer 810. The input/output controller 822 may also be arranged to output display information to a display device 824 which may be separate from or integral to the computing-based device 800. The display information may provide a graphical user interface, e.g. to enable a user to specify gestures for synthesizing and/or to provide any other inputs required. It may, in addition or instead, display the generated images or the resultant synthesized trace to the user. In an embodiment the display device 824 may also act as the user input device 823 if it is a touch sensitive display device. The input/output controller 822 may also output data to devices other than the display device, e.g. a locally connected printing device (not shown in FIG. 8).

The gesture synthesizer and methods of generating synthetic gesture traces described above are agnostic to the actual sensor being synthesized (e.g. sensor 106 in FIG. 1) as long as it can be suitably described (in the sensor parameters 118) and input to the gesture synthesizer 112. In an embodiment, the synthesizer may work for any rectangular capacitive sensor which operates at a known frequency (i.e. known frame rate) and provides a multi-level matrix output of capacitance values. As described above, the sensor may be part of a tablet computer, a mouse, a surface computer, a touch-sensitive television, a smart phone or any other computing device or peripheral.

As described above, the synthetic gesture traces generated using the methods and apparatus described above can be used in training or evaluating (i.e. testing) a gesture recognizer, which may be a parametric gesture recognizer, and which may be implemented in software or hardware. In an example, the synthetic gesture traces may be used to test very specific features, which may be the numerical limits of operation of the sensor (e.g. in terms of contact positions, gesture speeds etc) or at the limits of gesture recognition (e.g. where two gestures are very similar in one or more respects). Where gestures are defined in terms of regions of the sensor (e.g. a start region and/or an end region), the synthetic gestures may be used to explore the edges of these regions and to test that the gesture recognizer correctly classifies the gestures. In an example, a single input script may be used to define multiple gestures which explore the required test space. The synthetic gesture traces may also be used to test specific features to look at exactly what interpretation (by the gesture recognizer) results from a detailed scenario.

In a particular embodiment, the sensor (e.g. sensor 106 in FIG. 1) may be part of a touch-sensitive mouse and this mouse may be capable of multi-touch detection (and hence may be referred to as a ‘multi-touch mouse’). In this embodiment, the sensor parameters 118 define properties of the multi-touch mouse and the synthetic gesture traces generated using the methods and apparatus described above are synthetic gesture traces for a multi-touch mouse. The synthetic gesture traces which are generated (e.g. using gesture synthesizer 112) may be used in training or evaluating a gesture recognizer (e.g. gesture recognizer 102, which may be a parametric gesture recognizer) for use with a multi-touch mouse. In an example, the gesture recognizer being trained or tested may already be capable of recognizing gestures input via a different type of sensor (e.g. a touch-sensitive display) and the gesture recognizer may be being trained/tested such that it can additionally recognize gestures made on a multi-touch mouse.

The gesture recognizer may also be used to output files which can be used to control a test robot in order to perform verification of sensor devices. In such an example application, the test robot comprises a test finger with substantially the same characteristics as a real finger (for the purposes of detection of capacitance on a sensor) and the motion of the test finger on the device may be controlled using a file output by the gesture synthesizer. This file may comprise contact co-ordinate data and/or vector data, as described above. The resultant output from the sensor under test (e.g. images 108-110 in FIG. 1) can then be compared directly to the synthetic traces generated by the gesture synthesizer (e.g. images 114-116 in FIG. 1) to verify that the sensor is performing correctly or to identify problems in the operation of the sensor. In this example, the synthesizer generates both a robot control file and a synthetic gesture trace.

Although the present examples are described and illustrated herein as being implemented in a system in which much of the mathematics is performed within a normalized frame of reference, the system described is provided as an example and not a limitation. As those skilled in the art will appreciate, the present examples are suitable for application in a variety of different frames of reference and whilst normalization can simplify the computations required, the computations may be performed without this normalization.

In the description above, reference is made to detecting finger position and finger gestures and this is by way of example only. Although many systems use finger gestures, the methods described above are applicable to any gesture recognizer which receives an input from a capacitive touch sensor and the detected gestures may alternatively be made with a different part of the body or with an input device, such as a stylus or pen. It will be appreciated that the contact-to-sensor functions (e.g. as shown in the top part of FIG. 5) will be different dependent upon the implement used to perform the touch gesture. For multi-touch gestures, the same or different functions may be used for different gesture components (e.g. where the multi-touch gesture uses a finger and a thumb, different functions may be used for the gesture component corresponding to the finger motion and the gesture component corresponding to the thumb motion). Where multiple contact-to-sensor functions are (or may be) used, the contact-to-sensor functions to be used may be defined in the input script or in the gesture component.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A computer-implemented method of generating a synthetic gesture trace, the method comprising:
receiving, at a computer, gesture data defining a gesture to be synthesized with reference to one or more gesture components;
receiving, at the computer, parameters associated with a capacitive touch sensor;
loading data for each of the one or more gesture components referenced in the gesture data;
generating a series of time-stamped contact co-ordinates for each gesture component at a frame rate of the sensor;
constructing a sensor image for each time-stamp based on the series of time-stamped contact co-ordinates for each gesture component; and
outputting a synthetic gesture trace comprising the sensor images.

2. A computer-implemented method according to claim 1, wherein the synthetic gesture trace is output to a gesture recognizer.

3. A computer-implemented method according to claim 1, further comprising:
adding at least one blank sensor image after all the constructed sensor images, prior to outputting the synthetic gesture trace.

4. A computer-implemented method according to claim 1, wherein constructing a sensor image for each time-stamp based on the series of time-stamped contact co-ordinates for each gesture component comprises:
creating a blank sensor frame for each time-stamp;
selecting a first time-stamped contact co-ordinate from a series of time-stamped contact co-ordinates for a gesture component;
generating a sensor image using a contact-to-sensor function;
adding the generated sensor image to an existing sensor frame associated with the time-stamp of the selected contact co-ordinate;
repeating the generating and adding steps for each time-stamped contact co-ordinate in the series of time-stamped contact co-ordinates for each gesture component.

5. A computer-implemented method according to claim 1, wherein constructing a sensor image for each time-stamp based on the series of time-stamped contact co-ordinates for each gesture component comprises:
selecting a first time-stamped contact co-ordinate from a series of time-stamped contact co-ordinates for a gesture component;
generating a sensor image using a contact-to-sensor function;
adding the sensor image to any existing sensor image associated with the time-stamp of the selected contact co-ordinate;
repeating the generating and adding steps for each time-stamped contact co-ordinate in the series of time-stamped contact co-ordinates for each gesture component;
arranging the generated sensor images into a sequence of images in chronological order; and
inserting blank sensor images within the sequence for any time-stamps without an associated sensor image.

6. A computer-implemented method according to claim 5, wherein the capacitive touch sensor provides a multi-level output of capacitance values and contact-to-sensor function has the form:
y=(1−(w⁻²x²)).(1−(w⁻²z²)).h
where h is a maximum level of capacitance output by the sensor and w is a maximum width of the function.

7. A computer-implemented method according to claim 1, wherein generating a series of time-stamped contact co-ordinates for each gesture component at a frame rate of the sensor comprises:
generating a series of time-stamped contact co-ordinates for a gesture component;
determining if the gesture component data specifies jitter correction, and if jitter correction is specified in the data, adjusting each contact co-ordinate in the series of time-stamped contact co-ordinates for the gesture component by a random offset; and
repeating the generating, determining and adjusting steps for each gesture component.

8. A computer-implemented method according to claim 1, wherein generating a series of time-stamped contact co-ordinates for each gesture component at a frame rate of the sensor comprises:
generating a series of time-stamped contact co-ordinates for a gesture component;
determining if the gesture component data specifies a curvature correction value, and if a value is specified in the data, adjusting each contact co-ordinate in the series of time-stamped contact co-ordinates to lie on an arc defined by the specified value; and
repeating the generating, determining and adjusting steps for each gesture component.

9. A computer-implemented method according to claim 8, wherein the curvature correction value specifies an offset between a straight line and the arc at a midpoint between a start co-ordinate of the gesture component and an end co-ordinate of the gesture component.

10. A computer-implemented method according to claim 1, wherein the gesture data and the parameters associated with a capacitive touch sensor are received in a single input script.

11. A computer-implemented method according to claim 10, wherein the input script further comprises gesture data defining a second gesture to be synthesized with reference to one or more gesture components and wherein the method is repeated to generate and output a second synthetic gesture trace corresponding to the second gesture.

12. A computer-implemented method according to claim 1, wherein the synthetic gesture trace comprises a binary file of run-length encoded data and the trace is output in a file which further comprises a data block comprising information about the capacitive touch sensor.

13. A computer-implemented method according to claim 1, further comprising:
outputting a data file comprising control instructions for a robot which on execution cause the robot to replicate motion of the gesture.

14. One or more tangible device-readable media with device-executable instructions that, when executed by a computing system, direct the computing system to perform steps comprising:
receiving an input file defining at least one gesture to be synthesized, each gesture comprising at least one gesture component;
accessing a frame rate of a capacitive touch sensor;
accessing data for the at least one gesture component;
calculating a set of time-stamped contact co-ordinates at the frame rate of the sensor for each gesture component;
generating a series of sensor images at the frame rate of the sensor based on the set of time-stamped contact co-ordinates for each gesture component and a contact-to-sensor function;
formatting the series of sensor images to form a synthetic gesture trace; and
outputting the synthetic gesture trace.

15. One or more tangible device-readable media according to claim 14, further comprising device-executable instructions that, when executed by a computing system, direct the computing system to perform steps comprising:
adding at least one empty sensor image onto the end of the series of sensor images, prior to formatting the series of sensor images.

16. One or more tangible device-readable media according to claim 14, wherein formatting the series of sensor images to form a synthetic gesture trace comprises: creating a series of USB data packets wherein each USB data packet comprises data defining a part or a whole of a sensor image.

17. One or more tangible device-readable media according to claim 14, wherein the input file further comprises the frame rate of the sensor and physical dimensions of the sensor.

18. A method comprising:
receiving, at a computer, an input file comprising parameters associated with a capacitive touch sensor and data defining a gesture in terms of gesture components;
accessing data associated with the gesture components;
dividing each gesture component into a series of time-stamped contact co-ordinates at a frame rate of the touch sensor;
if the input file specifies jitter correction for a gesture component, adjusting the contact co-ordinates in the corresponding series of time-stamped contact co-ordinates by a random offset;
if the input file specifies a non-zero curvature correction parameter, adjusting the contact co-ordinates in the corresponding series of time-stamped contact co-ordinates to lie on an arc defined by the non-zero curvature correction parameter;
automatically constructing a sensor image corresponding to each frame of the touch sensor using the series of time-stamped contact co-ordinates and a contact-to-sensor function;
adding at least one blank sensor image following a last of the constructed sensor images;
formatting the sensor images to form a synthetic gesture trace; and
outputting the synthetic gesture trace for input into a gesture recognizer.

19. A method according to claim 18, wherein the input file further comprises data defining a second gesture in terms of gesture components and wherein the method is repeated to form and output a second synthetic gesture trace for input into a gesture recognizer.

20. A method according to claim 18, wherein the capacitive touch sensor comprises a touch sensor for a multi-touch mouse.
